(19) United States
(12) Patent Application Publication
(10) Pub. No.: US 2026/0127457 A1
(43) Pub. Date: May 7, 2026

(54) AUTOMATICALLY ENHANCING LARGE LANGUAGE MODEL INFERENCES

(71) Applicant: INTUIT INC., Mountain View, CA (US)

(72) Inventors: Sumangal MANDAL, Bangalore (IN); Vaishali GUPTA, Bangalore (IN); Amit KAUSHAL, Bangalore (IN)

(73) Assignee: INTUIT INC., Mountain View, CA (US)

(21) Appl. No.: 18/938,229

(22) Filed: Nov. 5, 2024

(51) Int. Cl. G06N 5/04

(52) U.S. Cl. CPC G06N 5/04

(57) ABSTRACT

At least one processor can receive a prompt from a source. The at least one processor can determine a context of the prompt. The at least one processor can retrieve a plurality of recipes associated with the context from at least one database. The at least one processor can modify the prompt according to at least one of the plurality of recipes, thereby obtaining a mutated prompt. The at least one processor can input the mutated prompt to a large language model (LLM) and obtain an LLM output in response. The at least one processor can provide the LLM output to the source.

### BACKGROUND

Many computer systems use large language models (LLMs) to perform various tasks. For example, user interfaces (UIs) can leverage LLMs to receive and respond to user input in a conversational manner, or programmers may provide high level plain language coding instructions to LLMs, which can write portions of code in response. Many computer systems that employ LLMs integrate off-the-shelf LLM products and/or access LLM products provided and/or hosted by third parties.

LLMs, especially off-the shelf and/or third-party LLMs, generally are not configured to be internally modified. LLMs can only be manipulated by tuning parameters and/or carefully writing prompts, a process known as “prompt engineering.” Users can perform some prompt engineering themselves, but the users may not know how to engineer a prompt and/or may require multiple tries to arrive at a prompt that works.

Accordingly, some systems automatically modify a user's input by adding meta-instructions or otherwise “mutating” a prompt to have a form and/or substance that may be more likely to elicit a desired and/or correct response from the LLM. Prompt mutation can improve the quality of LLM outputs, and prompt mutation systems and techniques exist. However, existing prompt mutation techniques mostly operate without reference to a context of the user's prompt, or to the extent they reference the context, such reference is limited and static in nature or requires multiple complex processing steps in order to arrive at an approximation of the context.

### BRIEF DESCRIPTIONS OF THE DRAWINGS

FIG. 1 shows an example automatic LLM inference enhancement system according to some embodiments of the disclosure.

FIG. 2 shows an example automatic LLM inference enhancement process according to some embodiments of the disclosure.

FIG. 3 shows example prompt modifications and/or mutations according to some embodiments of the disclosure.

FIG. 4 shows an example process of creating and retrieving a recipe according to some embodiments of the disclosure.

FIG. 5 shows an example mutation process according to some embodiments of the disclosure.

FIG. 6 shows an example mutation according to some embodiments of the disclosure.

FIG. 7 shows an example computing device according to some embodiments of the disclosure.

### DETAILED DESCRIPTION OF SEVERAL EMBODIMENTS

Systems and methods described herein can improve prompt mutation by automatically determining the domain of a prompt, prefetching conditional mutations that may apply to the domain, and mutating the prompt using mutations for which conditions are met, thereby providing a domain-specific, conditionally appropriate mutated prompt in one shot. For example, disclosed embodiments can intercept a user's input prompt and capture an LLM output for the prompt by calling the LLM internally. Leveraging a set of domain-specific mutation recipes stored in a vector space, the system can autonomously refine the prompt based on the initial interaction. Each applicable recipe can be sequentially applied to gradually mutate the input prompt, thereby forming a hyper-mutated prompt. Once the hyper-mutated prompt is formulated, the system can send the hyper-mutated prompt to the LLM to generate a more satisfactory output. This process enhances productivity by reducing the need for manual prompt adjustments, lowering new users' learning curve, and ultimately improving the overall user experience. Moreover, this process improves the standard technical procedure of prompt mutation by adding automatic domain detection and one-shot conditional mutation.

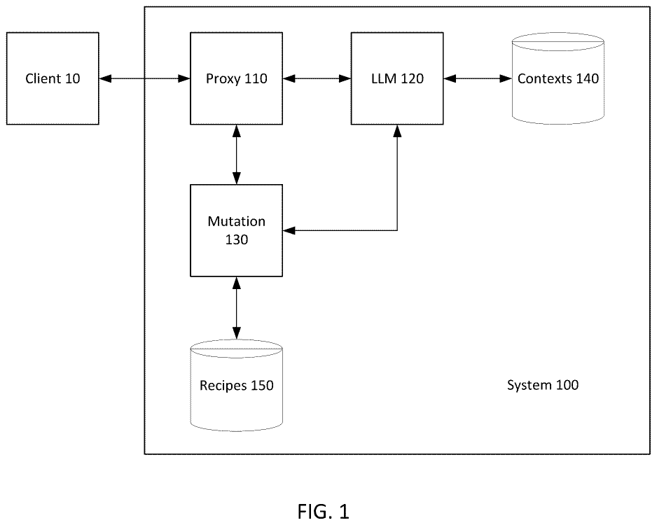

FIG. 1 shows an example automatic LLM inference enhancement system 100 according to some embodiments of the disclosure. System 100 may include a variety of hardware, firmware, and/or software components that interact with one another and/or with external components, such as client 10. The components of system 100 can include, for example, proxy module 110, LLM 120, mutation module 130, context database 140, and/or recipe database 150. While not illustrated as such, LLM 120 may external to system 100 in some embodiments, for example a third-party hosted LLM or the like. These elements are described in greater detail below, but in general, a user of client 10 can send a prompt or information including and/or defining a prompt to system 100. System 100 can mutate the prompt as described in detail below, provide the mutated prompt to LLM 120, and provide a response from LLM 120 to client 10.

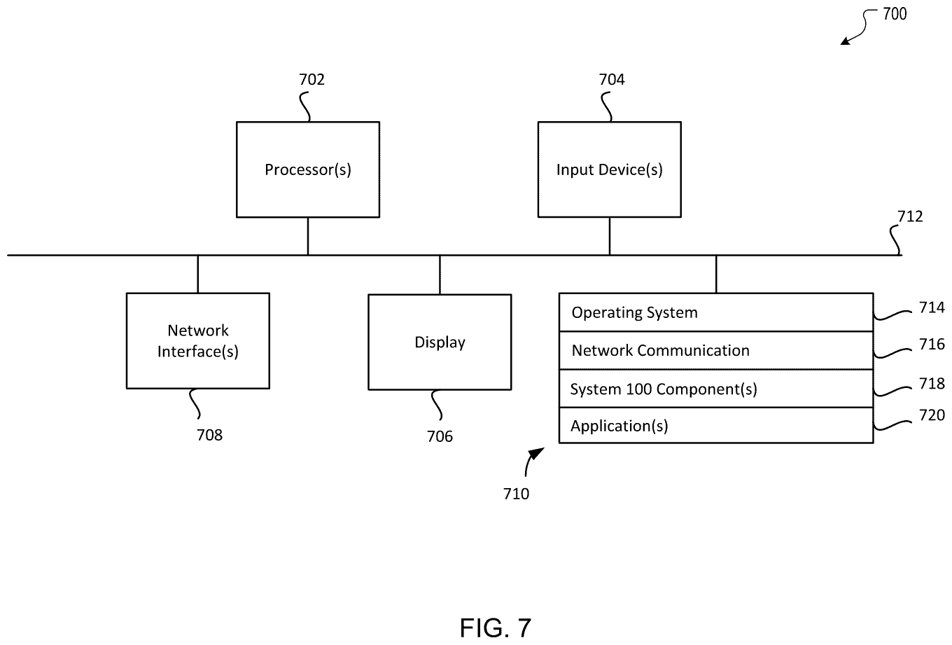

Some components within system 100 may communicate with one another using networks and/or locally. Some components may communicate with external components such as client 10 through one or more networks (e.g., the Internet, an intranet, and/or one or more networks that provide a cloud environment) and/or by other modes of data transfer. Each component may be implemented by one or more computers (e.g., as described below with respect to FIG. 7).

Elements illustrated in FIG. 1 (e.g., system 100 (including proxy module 110, LLM 120, mutation module 130, context database 140, and/or recipe database 150) and/or client 10) are each depicted as single blocks for ease of illustration, but those of ordinary skill in the art will appreciate that these may be embodied in different forms for different implementations. For example, while client 10 and system 100 are depicted separately, any combination of these elements may be part of a combined hardware, firmware, and/or software element. Likewise, while various elements such as proxy module 110, LLM 120, mutation module 130, context database 140, and recipe database 150 are depicted as parts of a single system 100, any combination of these elements may be distributed among multiple logical and/or physical locations. Also, while one client 10 and one system 100 are illustrated, this is for clarity only, and multiples of any of the above elements may be present. In practice, there may be single instances or multiples of any of the illustrated elements, and/or these elements may be combined or co-located.

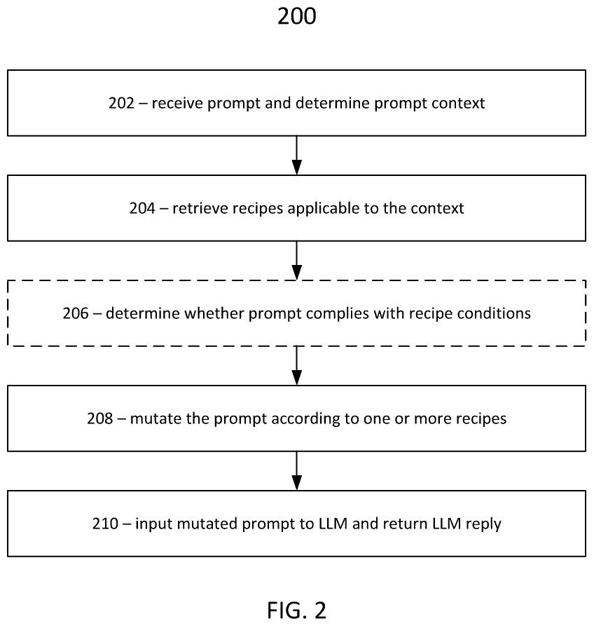

As described in detail below, system 100 can perform processing to automatically mutate prompts and provide responses to the mutated prompts in a more effective and efficient manner than other prompt mutation systems and/or techniques. For example, FIGS. 2-6 illustrate the functioning of the illustrated components in detail.

In the following descriptions of how system 100 functions, several examples are presented. However, those of ordinary skill in the art will appreciate that these examples are merely for illustration, and system 100 and its methods of use and operation are extendable to other application and data contexts.

FIG. 2 shows an example automatic LLM inference enhancement process 200 according to some embodiments of the disclosure. By performing process 200, system 100 can automatically mutate LLM prompts based on context and condition matching and supply improved LLM responses to user prompts as a result.

At 202, system 100 can receive prompt data and determine a context of the prompt data. For example, a user of client 10 can input a prompt into a UI, and client 10 can send the prompt to proxy module 110. In at least some embodiments, proxy module 110 can generate another prompt, which can include the text of the prompt received from client 10 and an instruction to identify the context of the prompt received from client 10. Proxy module 110 can send the text of the prompt and the instruction to LLM 120 and receive a response from LLM 120. The response from LLM 120 can include an answer to the prompt. The response from LLM 120 can also include the context of the prompt. In some embodiments, proxy module 110 can first send the prompt to LLM 120, receive a response from LLM 120, and then send the prompt and response together to the LLM 120 along with the instruction. LLM 120 can use retrieval augmented generation (RAG) to determine the prompt context from among contexts and/or context definitions stored in context database 140 in some embodiments.

For example, proxy module 110 can send an instruction to LLM 120 such as the following:
“Analyze the given prompt and following response and create a very brief summary of what the user is trying to achieve and what is offered in the response:
Prompt: { }
Response: { }.”

Leveraging data in context database 140, LLM 120 can identify a likely context definition and reply to the instruction above with a summary that incorporates or is otherwise based on the context definition.

At 204, system 100 can retrieve a plurality of recipes associated with the context from recipe database 150. For example, mutation module 130 can receive the context information returned by LLM 120 at 202 and search recipe database 150 using at least one term from the context information and/or at least one vector formed and/or otherwise derived from the context information or a portion thereof. As described in detail below, each recipe can define one or more changes to a prompt and, in at least some embodiments, one or more conditions under which the changes can be applied.

At 206, system 100 can determine whether the prompt from client 10 complies with any of the conditions of any of the recipes retrieved at 204, in embodiments wherein the recipes include conditions. For example, some or all recipes can respectively include at least one respective condition for applying the respective recipe to modify the prompt. Mutation module 130 can determine that the prompt complies with at least one respective condition of at least one of the plurality of recipes, for example by inputting the prompt and the at least one respective condition to LLM 120 and receiving an indication that the prompt complies with the at least one respective condition from LLM 120 in response. Examples of determining whether the prompt from client 10 complies with any of the conditions of any of the recipes retrieved at 204 are described in detail below.

In some embodiments, if none of the conditions apply for any of the mutations, system 100 can input the original prompt without mutations to LLM 120 and receive an LLM 120 output in reply from LLM 120. The response from LLM 120 does not benefit from mutation, but at least the user is not left without any response at all. Proxy module 110 can provide the LLM 120 output to client 10. Client 10 can provide the LLM 120 output or a portion thereof as a reply to the user in a UI, for example. In this situation, process 200 may end at this point.

In other embodiments, if none of the conditions apply for any of the mutations, proxy module 110 can request additional information from client 10 and receive the additional information from client 10. System 100 can then try again to determine mutations having applicable conditions. For example, mutation module 130 can input the prompt, the additional information, and an instruction to identify the context to LLM 120, receive the context from LLM 120 in response to the prompt, the instruction, and the additional information, identify more and/or different recipes related to the new context as described above, and test the newly identified recipes' conditions against the prompt. When at least one recipe applies, processing may proceed.

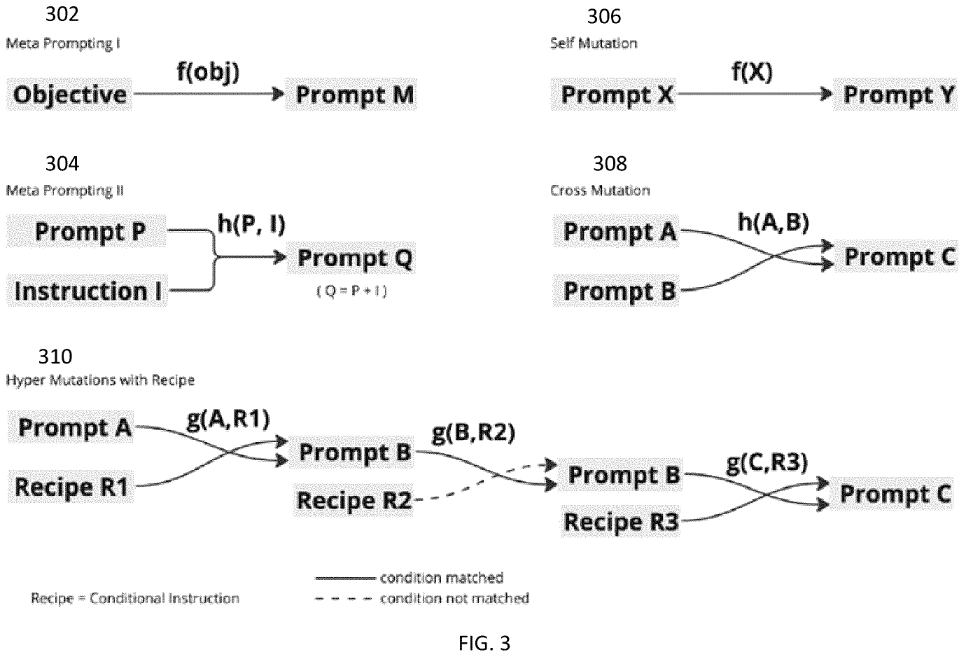

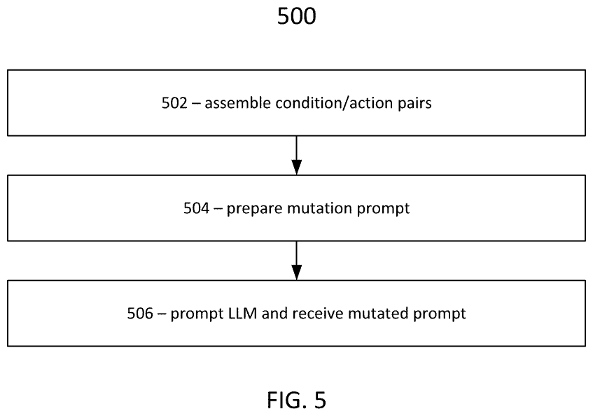

At 208, system 100 can mutate the prompt according to the one or more recipes determined to apply to the prompt. For example, mutation module 130 can modify the prompt in response to the determining that the prompt complies with the at least one respective condition of the at least one of the plurality of recipes at 206 in some embodiments. As described in detail below (for example with respect to FIG. 3 and/or FIG. 5), in some embodiments and/or use cases, mutation module 130 may have determined that two or more recipes have conditions met. Accordingly, mutation module 130 can perform hypermutation, wherein after mutation, the mutated prompt includes changes specified by each of the two or more of the plurality of recipes. For example, mutation module 130 can apply changes specified by respective ones of the two or more of the plurality of recipes sequentially to obtain the mutated prompt.

At 210, system 100 can input the mutated prompt to LLM 120 and receive an LLM 120 output in reply from LLM 120. Due to the mutations in the prompt, it may be expected that the LLM 120 output can provide a more responsive answer to the user's request than a response to an unmutated prompt would provide. Proxy module 110 can provide the LLM 120 output to client 10. Client 10 can provide the LLM 120 output or a portion thereof as a reply to the user in a UI, for example.

FIG. 3 shows example prompt modifications and/or mutations according to some embodiments of the disclosure. The prompt changes shown in FIG. 3 are non-exhaustive examples of possible changes that may be specified by recipes and applied by mutation module 130, for example at 208 of process 200, and/or of meta prompts that may be supplied to LLM 120 at 202 and/or 206 of process 200.

Some examples of how prompts can be modified before sending to LLM 120 are examples of meta prompting, such as meta prompt I 302 and meta prompt II 304. Meta prompting refers to the technique of using higher-order prompts to guide and fine-tune the behavior of a model such as LLM 120. Meta prompting can include creating prompts that do not merely request direct output, but also function to shape the nature, style, or process of generating that output. Meta prompting can be used to adjust a processing approach taken by LLM 120 in various ways without altering the underlying architecture or training data. Meta prompt I 302 is a straightforward example where a prompt is formed by simply stating an objective for LLM 120. Meta prompt II 304 is a slightly more elaborate example wherein a prompt is provided with additional instructions. Processing at 202 of process 200, where proxy module 110 asks LLM 120 to process the prompt and reply with added instructions, is an example of meta prompt II 304. Processing at 206 of process 200, where mutation module 130 asks LLM 120 to determine whether a prompt complies with a condition, is another example of meta prompt II 304.

Self-mutation 306 and cross-mutation 308 are examples of prompt mutation. Prompt mutation involves the modification or evolution of prompts to improve the quality, relevance, or effectiveness of responses generated by a model such as LLM 120. Self-mutation 306 is an iterative process where a prompt is continuously refined by the model itself or by a user revising it based on the feedback or output. For example, a user may provide a prompt, review the response, modify the prompt based on the output, and repeat the process until the desired quality of response is achieved. Cross-mutation 308 involves taking elements from multiple different prompts and combining them to create a hybrid prompt meant to leverage the strengths of each original input. Cross-mutation can help generate more nuanced or comprehensive responses by incorporating diverse perspectives or approaches within a single prompt.

FIG. 3 also includes an example of hypermutation 310. Hypermutation 310 is an advanced form of prompt mutation wherein changes to the prompt happen at an accelerated rate or on a larger scale. In some examples, hypermutation 310 can include multiple, significant alterations made quickly to adapt to a rapidly changing context or to explore a broad spectrum of possibilities. Hypermutation 310 can quickly find highly optimized or innovative prompts that yield exceptional performance from a model such as LLM 120. Hypermutation 310 can be particularly relevant in the context of fine-tuning models for specific tasks, ensuring adaptability, and optimizing performance to meet user requirements across different scenarios. Application of one or more recipes as 208 of process 200 is an example of hypermutation 310. In particular, the example hypermutation 310 is one wherein three recipes (R1, R2, and R3) were retrieved, and the initial prompt A was found to have two conditions met, those for R1 and for R3. Conditions for R2 were not satisfied. Accordingly, mutation module 130 sequentially applied mutations of R1 and R3 to arrive at a final prompt C.

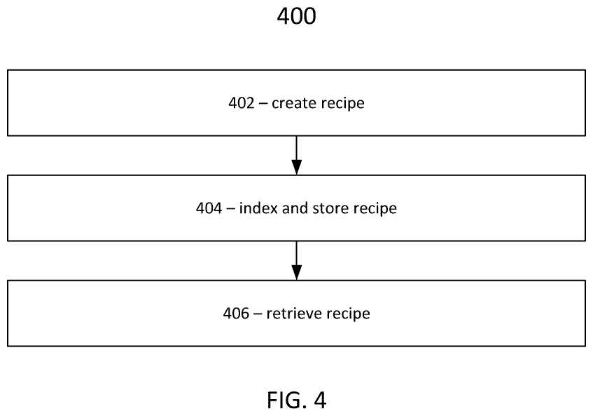

FIG. 4 shows an example process 400 of creating and retrieving a recipe according to some embodiments of the disclosure. System 100 can perform process 400 during a recipe's lifecycle, first creating the recipe, then provisioning recipe database 150 with the recipe, and then using the recipe, for example in process 200.

At 402, system 100 can create a recipe. The recipe can include a structured set of instructions and/or queries designed to solve a specific problem and/or perform a specific task. The instructions and/or queries can be in the form of prompts for LLM 120. In some embodiments, experts and/or automated systems can write the recipe. In at least some embodiments, recipes can have a given structure. As a non-limiting example, recipes can be structured as follows:

```
[
  {
    condition: “the user is trying to...”
    action: “mutate the prompt so that...”
  }
]
```

At 404, system 100 can index and store the recipe. For example, system 100 can add one or more tags, metadata, and/or other indexing data enabling search and retrieval of the recipe. The added indexing data can associate the recipe with one or more contexts stored in context database 140, for example. Accordingly, the recipe can be searchable by context. System 100 can store the recipe, along with its indexing data, in recipe database 150. In some embodiments, recipe database 150 can be a vector database, relational database, or other structured database, and system 100 can format the recipe and/or indexing data for storage according to applicable database schema.

At 406, system 100 can retrieve and/or use the recipe. For example, at 202 of process 200, mutation module 130 can receive context data from LLM 120 and, at 204 of process 200, search recipe database 150 for recipes having the context indicated within the context data. Due to the indexing and storing performed at 404, mutation module 130 can locate and retrieve recipes related to the context of interest.

FIG. 5 shows an example mutation process 500 according to some embodiments of the disclosure. System 100 can perform process 500 to evaluate recipe conditions at 206 of process 200 and to mutate the original prompt at 208 of process 200.

At 502, system 100 can assemble condition and action pairs. For example, system 100 can extract the conditions and actions from each recipe identified at 204 of process 200.

At 504, system 100 can prepare a mutation prompt including the condition and action pairs from 502. The mutation prompt can set up the task for LLM 120, indicate the condition and action pairs, and provide instructions for evaluating the conditions and incorporating applicable actions into a final mutation prompt. As a non-limiting example, a mutation prompt may be as follows:

You are a helpful assistant who can identify the difference between LLM prompts. A set of “condition” and “action” on prompt is given below:
condition: { }
action: { }
condition: { }
action: { }

Analyze the given prompt and following response. Only if a “condition” is true, and “action” is not applied already, then mutate the “prompt” using the “action” to generate the “enhanced prompt.”

Generate only the enhanced prompt and nothing else.
prompt: { }
response: { }
formatting instruction:
enhanced prompt: { }

At 506, system 100 can input the mutation prompt to LLM 120 and receive a mutated prompt in reply. The mutated prompt can be in condition for final processing by LLM 120 at 210 of process 200, for example. The mutated prompt can incorporate all recipe elements that apply to the context in view of the evaluated conditions.

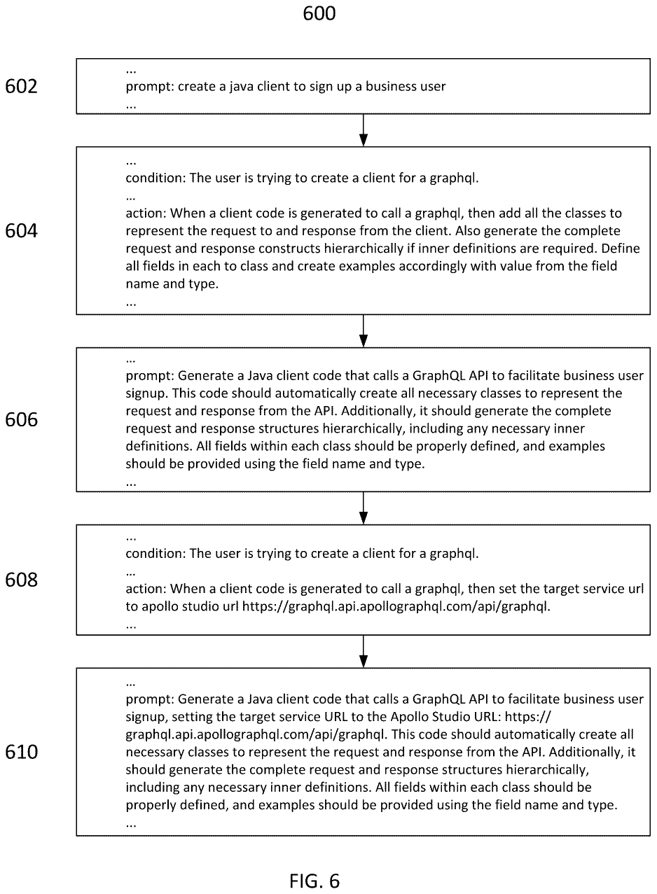

FIG. 6 shows an example mutation 600 according to some embodiments of the disclosure. Mutation 600 may be performed by system 100, for example in the course of system 100 performing process 200 and/or subprocesses thereof (e.g., process 400 and/or process 500). Example mutation 600 is presented as a specific, non-limiting example to illustrate how the disclosed embodiments can change a prompt to improve LLM 120 responsiveness and accuracy.

Initial prompt 602 is the prompt as received from client 10, for example at 202 of process 200. As described above, system 100 can determine the context of initial prompt 602 and retrieve recipes relevant to the context. Here, the recipes include first recipe 604 and second recipe 608.

System 100 can apply first recipe 604 to initial prompt 602 as described above. This can produce first mutation 606. As shown in FIG. 6, first mutation 606 alters initial prompt 602 according to first recipe 604 because the condition in first recipe 604 is met.

After applying first recipe 604 and obtaining first mutation 606, system 100 can apply second recipe 608 to first mutation 606. Again, the condition in second recipe 608 has been met. After applying second recipe 608, system 100 obtains second mutation 610.

LLM 120 can process second mutation 610 to provide a response to initial prompt 602 as described above. Note that, to the user of client 10, it can appear that the response was made directly subsequent to initial prompt 602, and no meta prompting was required on the part of the user. Moreover, the response is sensitive to both the context of initial prompt 602 and the conditions applicable to first recipe 604 and second recipe 608. Discovering the context of initial prompt 602 makes the end result more responsive without requiring user input of further details, while hypermutations from a plurality of recipes allow the prompt to be enriched with specifically applicable detail. As discussed above, this highly responsive result is achieved in a single shot, providing both computational efficiency and user convenience.

FIG. 7 shows a computing device 700 according to some embodiments of the disclosure. For example, computing device 700 may function as system 100 or any portion(s) thereof, or multiple computing devices 700 may function as system 100.

Computing device 700 may be implemented on any electronic device that runs software applications derived from compiled instructions, including without limitation personal computers, servers, smart phones, media players, electronic tablets, game consoles, email devices, etc. In some implementations, computing device 700 may include one or more processors 702, one or more input devices 704, one or more display devices 706, one or more network interfaces 708, and one or more computer-readable mediums 710. Each of these components may be coupled by bus 712, and in some embodiments, these components may be distributed among multiple physical locations and coupled by a network.

Display device 706 may be any known display technology, including but not limited to display devices using Liquid Crystal Display (LCD) or Light Emitting Diode (LED) technology. Processor(s) 702 may use any known processor technology, including but not limited to graphics processors and multi-core processors. Input device 704 may be any known input device technology, including but not limited to a keyboard (including a virtual keyboard), mouse, track ball, and touch-sensitive pad or display. Bus 712 may be any known internal or external bus technology, including but not limited to ISA, EISA, PCI, PCI Express, NuBus, USB, Serial ATA or FireWire. In some embodiments, some or all devices shown as coupled by bus 712 may not be coupled to one another by a physical bus, but by a network connection, for example. Computer-readable medium 710 may be any medium that participates in providing instructions to processor(s) 702 for execution, including without limitation, non-volatile storage media (e.g., optical disks, magnetic disks, flash drives, etc.), or volatile media (e.g., SDRAM, ROM, etc.).

Computer-readable medium 710 may include various instructions 714 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 704; sending output to display device 706; keeping track of files and directories on computer-readable medium 710; controlling peripheral devices (e.g., disk drives, printers, etc.) which can be controlled directly or through an I/O controller; and managing traffic on bus 712. Network communications instructions 716 may establish and maintain network connections (e.g., software for implementing communication protocols, such as TCP/IP, HTTP, Ethernet, telephony, etc.).

System 100 components 718 may include instructions for performing the processing described herein. For example, system 100 components 718 may provide instructions for performing any and/or all of process 200, process 400, process 500, and/or other processing as described above. Application(s) 720 may be an application that uses or implements the outcome of processes described herein and/or other processes. In some embodiments, the various processes and/or portions thereof may also be implemented in operating system 714.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by at least one processor, a prompt from a source;
determining, by the at least one processor, a context of the prompt;
retrieving, by the at least one processor, a plurality of recipes associated with the context from at least one database;
modifying, by the at least one processor, the prompt according to at least one of the plurality of recipes, thereby obtaining a mutated prompt;
inputting, by the at least one processor, the mutated prompt to a large language model (LLM) and obtaining an LLM output in response; and
providing, by the at least one processor, the LLM output to the source.

2. The method of claim 1, wherein the determining of the context of the prompt comprises:
inputting, by the at least one processor, the prompt and an instruction to identify the context to the LLM; and
receiving, by the at least one processor, the context from the LLM in response to the prompt and the instruction.

3. The method of claim 1, wherein:
each respective recipe includes at least one respective condition for applying the respective recipe to modify the prompt;
the method further comprises determining, by the at least one processor, that the prompt complies with the at least one respective condition of the at least one of the plurality of recipes; and
the modifying is performed in response to the determining that the prompt complies with the at least one respective condition of the at least one of the plurality of recipes.

4. The method of claim 3, wherein the determining that the prompt complies with the at least one respective condition of the at least one of the plurality of recipes comprises:
inputting, by the at least one processor, the prompt and the at least one respective condition to the LLM; and
receiving, by the at least one processor, an indication that the prompt complies with the at least one respective condition from the LLM in response to the prompt and the at least one respective condition.

5. The method of claim 1, wherein:
the at least one of the plurality of recipes comprises two or more of the plurality of recipes; and
the mutated prompt as input to the LLM includes changes specified by each of the two or more of the plurality of recipes.

6. The method of claim 5, wherein the modifying comprises applying changes specified by respective ones of the two or more of the plurality of recipes sequentially to obtain the mutated prompt.

7. The method of claim 1, wherein the retrieving of the plurality of recipes includes searching the at least one database using at least one term from the context.

8. The method of claim 1, wherein the retrieving of the plurality of recipes includes searching the at least one database using at least one vector derived from the context.

9. A method comprising:
receiving, by at least one processor, a prompt from a source;
determining, by the at least one processor, a context of the prompt, the determining of the context of the prompt comprising:
inputting, by the at least one processor, the prompt and an instruction to identify the context to a large language model (LLM), and
receiving, by the at least one processor, the context from the LLM in response to the prompt and the instruction;
retrieving, by the at least one processor, a plurality of recipes associated with the context from at least one database, each respective recipe including at least one respective condition for applying the respective recipe to modify the prompt;
determining, by the at least one processor, that the prompt complies with the at least one respective condition of the at least one of the plurality of recipes, the determining that the prompt complies with the at least one respective condition of the at least one of the plurality of recipes comprising:
inputting, by the at least one processor, the prompt and the at least one respective condition to the LLM, and
receiving, by the at least one processor, an indication that the prompt complies with the at least one respective condition from the LLM in response to the prompt and the at least one respective condition;
in response to the determining that the prompt complies with the at least one respective condition of the at least one of the plurality of recipes, modifying, by the at least one processor, the prompt according to at least one of the plurality of recipes, thereby obtaining a mutated prompt;
inputting, by the at least one processor, the mutated prompt to the LLM and obtaining an LLM output in response; and
providing, by the at least one processor, the LLM output to the source.

10. The method of claim 9, wherein:
the at least one of the plurality of recipes comprises two or more of the plurality of recipes; and
the mutated prompt as input to the LLM includes changes specified by each of the two or more of the plurality of recipes.

11. The method of claim 10, wherein the modifying comprises applying changes specified by respective ones of the two or more of the plurality of recipes sequentially to obtain the mutated prompt.

12. The method of claim 9, further comprising:
requesting, by the at least one processor, additional information in response to the receiving of the prompt; and
receiving, by the at least one processor, the additional information from the source;
wherein the determining the context of the prompt comprises:
inputting, by the at least one processor, the prompt, the additional information, and an instruction to identify the context to the LLM, and
receiving, by the at least one processor, the context from the LLM in response to the prompt, the instruction, and the additional information.

13. A system comprising:
at least one processor;
at least one database; and
at least one non-transitory computer-readable medium storing instructions that, when executed by the at least one processor, cause the at least one processor to perform processing comprising:
receiving a prompt from a source;
determining a context of the prompt;
retrieving a plurality of recipes associated with the context from the at least one database;
modifying the prompt according to at least one of the plurality of recipes, thereby obtaining a mutated prompt;
inputting the mutated prompt to a large language model (LLM) and obtaining an LLM output in response; and
providing the LLM output to the source.

14. The system of claim 13, wherein the determining of the context of the prompt comprises:
inputting the prompt and an instruction to identify the context to the LLM; and
receiving the context from the LLM in response to the prompt and the instruction.

15. The system of claim 13, wherein:
each respective recipe includes at least one respective condition for applying the respective recipe to modify the prompt;
the instructions further cause the at least one processor to perform processing comprising determining that the prompt complies with the at least one respective condition of the at least one of the plurality of recipes; and
the modifying is performed in response to the determining that the prompt complies with the at least one respective condition of the at least one of the plurality of recipes.

16. The system of claim 15, wherein the determining that the prompt complies with the at least one respective condition of the at least one of the plurality of recipes comprises:
inputting the prompt and the at least one respective condition to the LLM; and
receiving an indication that the prompt complies with the at least one respective condition from the LLM in response to the prompt and the at least one respective condition.

17. The system of claim 13, wherein:
the at least one of the plurality of recipes comprises two or more of the plurality of recipes; and
the mutated prompt as input to the LLM includes changes specified by each of the two or more of the plurality of recipes.

18. The system of claim 17, wherein the modifying comprises applying changes specified by respective ones of the two or more of the plurality of recipes sequentially to obtain the mutated prompt.

19. The system of claim 13, wherein the retrieving of the plurality of recipes includes searching the at least one database using at least one term from the context.

20. The system of claim 13, wherein the retrieving of the plurality of recipes includes searching the at least one database using at least one vector derived from the context.
